(19) United States
(12) Patent Application Publication
(10) Pub. No.: US 2022/0012801 A1
(43) Pub. Date: Jan. 13, 2022

(54) MULTIMEDIA POINT-OF-SALE NETWORK SYSTEM AND METHOD THEREFOR

(71) Applicants: Sabatino MADDALO, Heritage Pointe (CA); Paulette ANDERSON, Calgary (CA)

(72) Inventors: Sabatino MADDALO, Heritage Pointe (CA); Paulette ANDERSON, Calgary (CA)

(21) Appl. No.: 17/369,775

(22) Filed: Jul. 7, 2021

Related U.S. Application Data
(60) Provisional application No. 63/048,903, filed on Jul. 7, 2020.

(51) Int. Cl. G06Q 30/06; G06Q 20/20; G06Q 30/02

(52) U.S. Cl. CPC G06Q 30/0643; G06Q 30/0281; G06Q 30/0277; G06Q 20/202

(57) ABSTRACT

A multimedia point-of-sale (MMPOS) network system has a server, a plurality of client computing devices used by a plurality of customers, one or more MMPOS terminals deployed in one or more establishments, and a network. The system stores customers' profiles in a database. When a customer visits an establishment, the system identifies the customer, accesses the customer's profile, retrieves the allergy information and food preferences of the customer, displays a menu on a MMPOS terminal used by the customer, and highlights one or more first menu items on the menu based on the retrieved food preferences, and/or presents an alert on one or more second menu items on the menu based on the retrieved allergy information.

### CROSS-REFERENCE TO RELATED APPLICATIONS

This application claims the benefit of U.S. Provisional Patent Application Ser. No. 63/048,903 filed Jul. 7, 2021, the content of which is incorporated herein by reference in its entirety.

### FIELD OF THE DISCLOSURE

The present disclosure relates generally to a network system, and in particular to a multimedia point-of-sale network system for facilitating service providers to interact with clients.

### BACKGROUND

It is a common operational issues in service industries such as restaurants to reduce costs such as front of house (FOH) labor costs and food costs, and increase sales without compromising service for the restaurant. Other issues include how to promptly identify potential allergens on product offerings having one or more product items (e.g., menus having one or more menu items) and alert same to the service provider.

In prior art, tabletop order devices and systems are used for addressing the above-described issues. However, such systems are generally passive systems which only allow ordering of food and drinks and possibly pay at table. Such systems usually do not allow tracking of behavioral trends which can then be interpreted and used for future dining analysis of trends within the service establishment and other related hospitality industries.

### SUMMARY

Embodiments disclosed herein relate to a multimedia point-of-sale (MMPOS) network system for facilitating service providers to interact with clients. Unlike the conventional tabletop order devices and systems, the multimedia POS network system disclosed herein is a proactive systems.

The system disclosed herein builds profile data base of all customers visiting the establishments of the system using a customer recognition technology (CRT). The customer profiles may be shared with all establishments of the system.

The system disclosed herein is a proactive system. With the use of CRT, the ability of watching streaming events directly at the table, making payments directly on the MMPOS terminal, offering revolving billboards with national brand advertising, the system provides a multitude of revenue streams and capabilities.

In various embodiments, the system disclosed herein may provide:
CRT-based customer adaption in, e.g., food/beverage preference, allergy alert accommodations, and/or the like;
highly visual-compelling and engaging menus;
allergy alert and/or food preference identified and associated with the customer at all establishments;
menu items ingredients list, allowing customers to view ingredients and recipes of items thereby complementing allergy alert;
intuitive and easy, allowing order at table using MMPOS terminals;
pay at table using pre-stored payment methods (allowing the customer to verify the bill prior to settlement, and sending the customer a copy of the bill via email);
in-room messaging and/or table-to-table messaging (optionally with video);
instant commentaries and reviews;
on-demand calling to attendants;
customizable features from advertising to specials, promotions, and the like;
third-party sponsorships;
subscription services allowing easy deployment, technical support, and upgrades;
uninterrupted service, with fully-featured offline mode;
automatic sync and backup of relevant data; and
pre-loaded “guest relations manager” for customer to purchase e-gift cards and/or sign up for loyalty programs, allowing customers to collect and redeem points at any establishment of the system and allowing targeted marketing via short message service (SMS) or email.

According to one aspect of this disclosure, there is provided a multimedia point-of-sale (MMPOS) network system comprising: a first server; one or more client computing devices for use by a plurality of customers; and a network connecting the first server and the plurality of client computing devices; the first server comprises a database storing a plurality of customer profiles, the customer profiles comprising at least allergy information and/or food preferences of the plurality of customers; and the one or more client computing devices are configured for communicating with the first server for: identifying one of the plurality of customers; accessing, in the database, the profile of the identified customer; retrieving, from the database, the allergy information and/or food preferences of the identified customer; displaying a product offering having one or more product items on one of the one or more client computing devices associated with the identified customer; and highlighting first one or more of the product items on the product offering based on the retrieved food preferences, and/or presenting an alert on second one or more of the product items on the product offering based on the retrieved allergy information.

In some embodiments, the one or more client computing devices are further configured for communicating with the first server for: determining a location of one client computing device of the one or more client computing devices; if the determined location is within a predefined range of an establishment, enabling the client computing device to place an order; and if the determined location is outside the predefined range of an establishment, preventing the client computing device from placing an order.

In some embodiments, the one or more client computing devices comprise one or more MMPOS terminals deployed in one or more establishments.

In some embodiments, the one or more client computing devices comprise one or more laptop computers, tablets, smartphones, and/or Personal Digital Assistants (PDAs).

In some embodiments, the one or more client computing devices are configured for communicating with each other and/or a second server for playing games.

In some embodiments, the one or more client computing devices are configured for receiving input from the identified customer for commentaries and reviews.

In some embodiments, the one or more client computing devices comprise a plurality of MMPOS terminals deployed in an establishment; and plurality of MMPOS terminals are connected to a third server for in-room messaging and/or table-to-table messaging.

In some embodiments, the one or more client computing devices are configured for displaying ads.

In some embodiments, the one or more client computing devices are configured for receiving payment from the identified customer.

### BRIEF DESCRIPTION OF THE DRAWINGS

FIG. 1 is a schematic diagram of a multimedia point-of-sale (MMPOS) network system, according to some embodiments of the present disclosure; and

FIG. 2 is a schematic diagram showing the hardware structure of the server, client computing devices, and MMPOS terminals of the MMPOS network system shown in FIG. 1.

### DETAILED DESCRIPTION

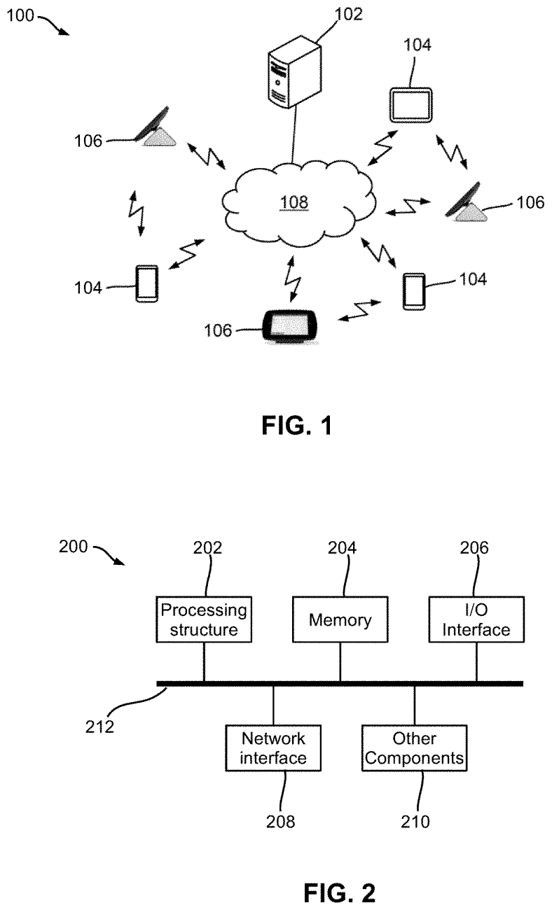

Turning now to FIG. 1, a multimedia point-of-sale (MMPOS) network system is shown and is generally identified using reference numeral 100. As shown, the MMPOS system 100 comprises a server computer 102, a plurality of client computing devices including one or more client computing devices 104 not specifically tied or deployed in establishments (e.g., restaurants) and one or more MMPOS terminals 106 deployed in establishments, functionally interconnected by a network 108.

Depending on implementation, the server computer 102 may be a server-computing device, and/or a general purpose computing device acting as a server computer while also being used by a user. The server computer 102 executes one or more server programs.

The client computing device 104 may be portable computing devices such as laptop computers, tablets, smartphones, Personal Digital Assistants (PDAs) and the like. However, those skilled in the art will appreciate that one or more client computing devices 104 may be non-portable computing devices such as desktop computers in some alternative embodiments. Each client computing device 104 executes one or more client application programs (or so-called “apps”) and for users to use.

The MMPOS terminal 106 is a portable electronic device used in establishments such as restaurants and/or bars. The MMPOS terminal 106 generally comprises a touch-sensitive screen for a customer to interact therewith and a communication module for connecting to the network 108 and/or for communication with other devices such as the client computing devices 104. The MMPOS terminal 106 may also comprise a speaker for streaming audio and video as desired by the customer from internal sources being broadcast by the establishment or from any outside source including from the server 102.

The MMPOS terminal 106 may comprise a support for positioning on a table with a suitable angle to the customer for facilitating the customer to operate. Alternatively, the MMPOS terminal 106 may be a portable device such as a tablet removably mountable to a stand. In some embodiments, the MMPOS terminal 106 may comprise or attach to a wall-mount for removably coupling to a wall of the establishment.

The network 108 may be any suitable network such as the Internet, a local area network (LAN), a wide area network (WAN), a metropolitan area network (MAN), and/or the like. The server computer 102, client computing devices 104, and MMPOS terminals 106 may be connected to the network 108 via suitable wired and wireless communication technologies.

Generally, the hardware of the system 100 may include devices readily in the market and devices customized or otherwise specialized for the specific needs of the system 100.

The server 102, client computing devices 104, and MMPOS terminals 106 may have a similar hardware structure 200 as shown in FIG. 2. As shown, each of the server 102, client computing devices 104, and MMPOS terminals 106 may comprise, for example, a processing structure 202, memory 204, an input/output (I/O) interface 206, a network interface 208 and a system bus 210 coupling the various computer components 204 to 208 for communication therebetween.

The processing structure 202 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The processing structure 202 may also be a real-time processor, a programmable logic controller (PLC), a microcontroller unit (MCU), a μ-controller (UC), a specialized/customized process/controller using e.g., field-programmable gate array (FPGA) or application-specific integrated circuit (ASIC) technologies, and/or the like.

The memory 204 comprises one or more storage devices or media accessible by the processing structure 202 for reading and/or storing instructions for the processing structure 202 to execute, and for reading and/or storing data, including input data and data generated by the processing structure 202. The memory may be volatile and/or non-volatile, non-removable or removable memory such as RAM, ROM, EEPROM, solid-state memory, hard disks, CD, DVD, flash memory, or the like.

The I/O interface 206 comprises input and output modules for inputting and outputting data. For example, the I/O interface 206 may be used to connect to input devices such as touch-sensitive screen, touch-sensitive whiteboard, touch-pad, keyboards, computer mouse, trackball, microphone, scanners, cameras, and/or the like, for receiving data therefrom, and may be used to connect to output devices such as monitors, LCD displays, LED displays, projectors, and the like), speakers, printers, virtual reality (VR) headsets, augmented reality (AR) goggles, and/or the like for outputting data thereto.

The network interface 208 comprises one or more network modules for connecting to other computing devices or networks through the network 108 by using suitable wired or wireless communication technologies such as Ethernet, WI-FI® (WI-FI is a registered trademark of Wi-Fi Alliance, Austin, Tex., USA), BLUETOOTH® (BLUETOOTH is a registered trademark of Bluetooth Sig Inc., Kirkland, Wash., USA), Bluetooth Low Energy (BLE), Z-Wave, Long Range (LoRa), ZIGBEE® (ZIGBEE is a registered trademark of ZigBee Alliance Corp., San Ramon, Calif., USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, 5G New Radio (5G NR) and/or other 5G networks, and/or the like. In some embodiments, parallel ports, serial ports, USB connections, optical connections, or the like may also be used for connecting other computing devices or networks although they are usually considered as input/output interfaces for connecting input/output devices.

In some embodiments, each of the client computing devices 104 and MMPOS terminals 106 may also comprise other components 210 such as one or more positioning modules for determining the location thereof. The positioning modules may comprise one or more global navigation satellite system (GNSS) components (e.g., one or more components for operation with the Global Positioning System (GPS) of USA, Global'naya Navigatsionnaya Sputnikovaya Sistema (GLONASS) of Russia, the Galileo positioning system of the European Union, and/or the Beidou system of China). The positioning modules may comprise a module using cellular-communication signals and the positions of associated based stations, WI-FI® signals and associated WI-FI® stations (e.g., WI-FI® router, WIFI® access point, and/or the like), and/or any other technologies suitable for indoor and/or outdoor positioning, for determining the location of the client computing devices 104 or MMPOS terminals 106.

The server 102, client computing devices 104, and MMPOS terminals 106 may run suitable operating systems such as MICROSOFT® WINDOWS® (MICROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDROID is a registered trademark of Google Inc., Mountain View, Calif., USA), or the like.

In some embodiments, the server computer 102 comprises a database for storing relative information such as customers' profiles (e.g., contact information, food preference, allergy information, history, past orders, rewards, redemptions, methods of payments, and/or the like), establishments' profiles, and food information.

When a customer visits an establishment, the system 100 uses a customer recognition technology (CRT) to determine the customer's identity prior to ordering at the MMPOS terminal 106. In various embodiments, the CRT may include various recognition means such as login via the smartphone app, smartphone's NFC functionality, face recognition, barcode, PIN, retina scan/recognition, and/or the like.

The system 100 then retrieves relevant information such as food preference, allergy information, and/or the like from the client's profile. The system 100 also retrieves relevant information such as food and drink menus, food ingredients, and/or the like from the establishment's profile. Based on the retrieved information, the system 100 may highlight the menu items within the customer's preference, alert the customer the menu items with the allergens (e.g., highlighting such menu items when displaying on the MMPOS terminal 106 and/or making a sound), and alert relevant people of the establishment the menu items with the allergens.

The customer may use a smartphone app running on their smartphone (which is a client computing device 104) to record and store experiences and choices into the database on the server 102 under the customer's unique profile when the customer visits an establishment. The client's unique profile is readily and instantly available, accessible, retrievable and recognizable across the system 100 to every establishment when the customer visits the establishment.

Thus, the system 100 may assist customers in their dining experience and also allows establishments to offer incentives for repeat patronage.

In some embodiments, the MMPOS terminal 106 may comprise a call button for calling an attendant-call device attached to the attendant (e.g., waiter/waitress) for communicating with the attendant.

In some embodiments, the MMPOS terminal 106 may display a revolving advertisement billboard to a targeted, captive audience (i.e., the customer) during all idle times (e.g., when the MMPOS terminal 106 is not being used by the customer). The billboard may show:
in-house advertising of specials, promotions, features events offered by the establishment;
national brand advertising of products and services; and
third-party advertisements.

The MMPOS terminal 106 may also allow a customer to play system games for entertainment; stream sports and games; and provide in-room messaging and/or table-to-table messaging (optionally with video) to customers via the server 102, or to customers in an establishment via a server computer therein.

In some embodiments, the system 100 may provide an affordable subscription-based service that covers data backup, software upgrades, and around-the-clock technical support. In some embodiments, the system 100 may also provide a trouble-shooting app and other features to facilitate technical support.

In some embodiments, the system 100 may also allow other staff members of the establishment to call the attendant-call devices attached to the attendants.

In some embodiments, the system 100 may provide live and end-of-day reporting.

In some embodiments, the system 100 may allow customers to input instant commentaries and reviews from their client computing devices 104 and/or the MMPOS terminals 106 and stored in the database on the server 102.

In some embodiments, the system 100 may allow an establishment to update their menus on the fly.

In some embodiments, the MMPOS 106 may be used for interacting on social media, checking Facebook, Twitter, reviewing restaurant experience, and the like.

In some embodiments, the MMPOS 106 may be used for playing online games and/or playing games with people on other tables.

The system 100 disclosed herein allows a customer to begin ordering immediately upon being seated in an establishment, and without waiting for the attendant to arrive. The system 100 may also allow the customer to place an order before arriving the establishment.

In various embodiments, the system 100 allows customers to order, pay, and get food/beverage information right at their table, on their own time, thereby freeing attendants to perform other functions. Attendants may greet and seat guests, bring orders to the table, clear and reset tables, and interact with guests at the click of a button on the tablet.

In some embodiments, a customer at a table of an establishment may use his/her client computing device 104 such as a smartphone place an order. The customer may use the smartphone executing an application program or app to scan an image (such as a one-dimensional barcode or a two-dimensional barcode or QR code) coded with, e.g., a link to the server 102, to connect to the server 102 and place an order. While the customer is placing the order, the app determines the location of the smartphone (and therefore the location of the customer) and sends the determined location to the server 102. The sever 102 checks if the received location of the customer is within the range of the establishment. If the received location of the customer is within the range of the establishment, the server 102 enables the customer's app to complete the ordering process for placing an order. If the received location of the customer is outside the range of the establishment, the server 102 prevents customer's app from placing an order (e.g., by disabling the order function or the customer's app, terminating the ordering process, and/or rejecting the order).

In some embodiments, the server 102 may execute an application program for tracking the status of customers' orders. The application program maintains a list of customer orders. When a service person (e.g., a waiter, a waitress, a bartender, or the like) of the establishment delivers an order to the corresponding customer, the service person may use his/her client computing device 104 (which is connected to the server 102 via the network 108) to update the status of the order, e.g., by clicking or touching a virtual button displayed on the client computing device 104.

In some embodiments, the food and beverage containers may each comprise a Radio-frequency identification (RFID) tag and the MMPOS 106 may comprise a RFID reader. When an order of food and/or beverage is delivered to a table, the MMPOS 106 detects the RFID tags of the containers delivered to the table and sends the detected RFID information to the server 102. The server 102 then automatically updates the status of the order associated with the table.

Thus, the system 100 disclosed herein provides a proactive approach to ensuring customers or guests get what they are looking for in a positive restaurant experience, e.g.,
MMPOS terminals 106 with user-friendly graphic user interface (GUI) with simple touch-screen technology allowing customers to see menu items and specials;
order-at-table;
pay-at-table;
maintaining attendant-customer contact with the call-function, bringing an attendant to the customer's table instantly when they need one;
customer controlling their own experience;
personalized customer experience through guest recognition at login instantly loading food and beverage preferences, across multiple establishments.
detailed information about ingredients and preparation, providing assurance to customers with allergies and personal preferences.

Customers may then enjoy a fun, easy, and customizable service experience. As a result, customers may frequently visit establishments where the system 100 is installed, and tell friends and family to visit.

The system 100 also facilitates labor-intensive restaurants and bars in many aspects such as:
offering fast, convenient, enjoyable guest experiences that generates repeat business; provides faster table turnover, thus accommodating more guests, thereby equating into more revenue;
the GUI of MMPOS terminals 106 providing enticing images of menu items which may help upsell food and beverages up to 20%;
increasing table-specific revenue through upsells, promotions, daily food and beverage specials, and advertising;
issuing coupons and redemption at the customer's table (e.g., sending coupons to customers' smartphones, emails, or printed at the establishment);
selling gift cards and conducting in house surveys;
reducing labor costs with the reduction of front-of-house service staff requirements;
increasing impulse buying by rotating billboard and system suggestive selling (e.g., increasing sales by 12-20%);
empowering hospitality;
new revenue streams beyond food and beverage sales;
the ability to reduce staff count and help right-size staff to accommodate slow and busy time periods;
the ability to reduce FOH wage expenses by up to 30% and/or reduce labor on FOH by over 30%; and
reducing food cost by reducing the amount of orders returned due to attendant's errors.

Below is a comparison showing the savings on the FOH staff that the system 100 may cause. In the comparison, an exemplary 5,000-square-foot restaurant with 150 to 200 seats with a minimum wage of $15/hour is used.

| Conventional establishment | |
|---|---|
| without the system 100 | Establishment with the system 100 |
| Monday to Thursday Daytime | Monday-Thursday Daytime |
| 3 servers = 64 hours over 4 days | 2 servers = 48 hours over 4 days |
| Friday Daytime | Friday Daytime |
| 4 servers = 20 hours | 3 servers =17 hours |
| Weekend Daytime | Weekend Daytime |
| 4 servers = 48 hours over 2 days | 3 servers = 38 hours over 2 days |
| Sunday-Thursday Nighttime | Sunday-Thursday Nighttime |
| 4 servers = 115 hours over 5 days | 3 servers = 85 hours over 5 days |
| Friday-Saturday Nighttime | Friday-Saturday Nighttime |
| 8 servers = 142 hours over 2 days | 5 servers = 70 hours over 2 days |
| Total Shift Hours | Total Shift Hours |
| 389 @ $15/hour = $5,835/week | 258 @ $15/hour = $3,870/week |
| Annual Labour Cost: $303,420 | Annual Labour Cost: $201,240 |

With fewer workers without compromising customer experiences, the system 100 may give rise to a potential FOH labor cost savings of up to 33%.

Although embodiments have been described above with reference to the accompanying drawings, those of skill in the art will appreciate that variations and modifications may be made without departing from the scope thereof as defined by the appended claims.

What is claimed is:

1. A multimedia point-of-sale (MMPOS) network system comprising:
a first server;
one or more client computing devices for use by a plurality of customers; and
a network connecting the first server and the plurality of client computing devices;
wherein the first server comprises a database storing a plurality of customer profiles, the customer profiles comprising at least allergy information and/or food preferences of the plurality of customers; and
wherein the one or more client computing devices are configured for communicating with the first server for:
identifying one of the plurality of customers;
accessing, in the database, the profile of the identified customer;
retrieving, from the database, the allergy information and/or food preferences of the identified customer;
displaying a product offering having one or more product items on one of the one or more client computing devices associated with the identified customer; and
highlighting first one or more of the product items on the product offering based on the retrieved food preferences, and/or presenting an alert on second one or more of the product items on the product offering based on the retrieved allergy information.

2. The MMPOS network system of claim 1, wherein the one or more client computing devices are further configured for communicating with the first server for:
determining a location of one client computing device of the one or more client computing devices;
if the determined location is within a predefined range of an establishment, enabling the client computing device to place an order; and
if the determined location is outside the predefined range of an establishment, preventing the client computing device from placing an order.

3. The MMPOS network system of claim 1, wherein the one or more client computing devices comprise one or more MMPOS terminals deployed in one or more establishments.

4. The MMPOS network system of claim 1, wherein the one or more client computing devices comprise one or more laptop computers, tablets, smartphones, and/or Personal Digital Assistants (PDAs).

5. The MMPOS network system of claim 1, wherein the one or more client computing devices are configured for communicating with each other and/or a second server for playing games.

6. The MMPOS network system of claim 1, wherein the one or more client computing devices are configured for receiving input from the identified customer for commentaries and reviews.

7. The MMPOS network system of claim 1, wherein the one or more client computing devices comprise a plurality of MMPOS terminals deployed in an establishment; and
wherein plurality of MMPOS terminals are connected to a third server for in-room messaging and/or table-to-table messaging.

8. The MMPOS network system of claim 1, wherein the one or more client computing devices are configured for displaying ads.

9. The MMPOS network system of claim 1, wherein the one or more client computing devices are configured for receiving payment from the identified customer.
